(19) United States
(12) Patent Application Publication
(10) Pub. No.: US 2001/0028400 A1
(43) Pub. Date: Oct. 11, 2001

(54) Light filter adapted for use with a charge-coupled device

(76) Inventors: Chieh-Jen Lee, Taichung (TW); Pai-Hung Chien, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/804,304

(22) Filed: Mar. 13, 2001

(30) Foreign Application Priority Data
Apr. 11, 2000 (TW) 89106680

(51) Int. Cl. H04N 5/335; H04N 9/04

(52) U.S. Cl. 348/273; 348/276; 257/440

(57) ABSTRACT

A light filter having a plurality of light-filtering portions of thin, medium and thick thickness corresponding to the red, green and blue photosensitive pixels of a charge-coupled device disposed behind the filter for enabling red, green and blue colors of light from a front lens to be respectively focused, refracted and then focused accurately onto the photosensitive pixels of the charge-coupled device on the same plane, so as to improve the image quality.

### BACKGROUND OF THE INVENTION

The present invention relates to CCD (charge-coupled device) and, more particularly, to a light filter, which is capable of accurately projecting the light of the three prime colors of different wavelengths onto the CCD after refraction.

A regular light filter for use with a CCD (charge-coupled device) is a single-piece, light-penetrable plate member having parallel front and back surfaces and filter color elements corresponding to the photosensitive pixels of the CCD and adapted to focus the three prime colors onto the corresponding photosensitive pixels of the CCD respectively. However, because red, green and blue colors have different wavelengths, they are imaged on locations at different distances after refracted and focused by the lens. As illustrated in FIG. 1, red, green and blue colors of light are focused through the lens 81, and then filtered through the light filter 83, and then imaged onto the CCD 85 at different distances. In comparison with the focusing of green light onto the CCD, blue light has a relatively shorter wavelength and greater refraction rate so the focal point of blue light is in front of the CCD 85. However, red light has a relatively greater wavelength and smaller refraction rate, the focal point of red light is behind the CCD 85, i.e., the red, green and blue colors cannot be accurately focused onto the CCD, resulting in a poor quality of image. It is difficult to design a lens for enabling the three prime colors to be accurately onto the same focal point.

### SUMMARY OF THE INVENTION

The present invention has been accomplished to provide a light filter, which eliminates the aforesaid problem. It is the main object of the present invention to provide a light filter for use with a CCD (charge-coupled device), which enables the light of red, green and blue colors to be accurately focused onto the CCD, so as to improve the quality of the image obtained. According to the present invention, the light filter has a plurality of light-filtering portions of thin, medium and thick thickness corresponding to the red, green and blue photosensitive pixels of a charge-coupled device disposed behind the filter for enabling red, green and blue colors of light refracting through the light filter to be focused onto the charge-coupled device at the same distance. Before refracted through the light filter, the red, green, and blue color of light have been focused by lens. Because red, green and blue colors of light are focused onto the CCD at the same distance, the image quality is greatly improved.

### BRIEF DESCRIPTION OF THE DRAWINGS

FIG. 1 illustrates the focusing of the three prime colors through a light filter according to the prior art.

FIG. 2 is a front view of a preferred embodiment of the present invention.

FIG. 3 is a sectional view taken along line 3-3 of FIG. 2.

FIG. 4 is a schematic drawing explaining refraction of light of a preferred embodiment of the present invention.

FIG. 5 illustrates the focusing of the three prime colors through a light filter of a preferred embodiment of the present invention.

### DETAILED DESCRIPTION OF THE PREFERRED EMBODIMENT

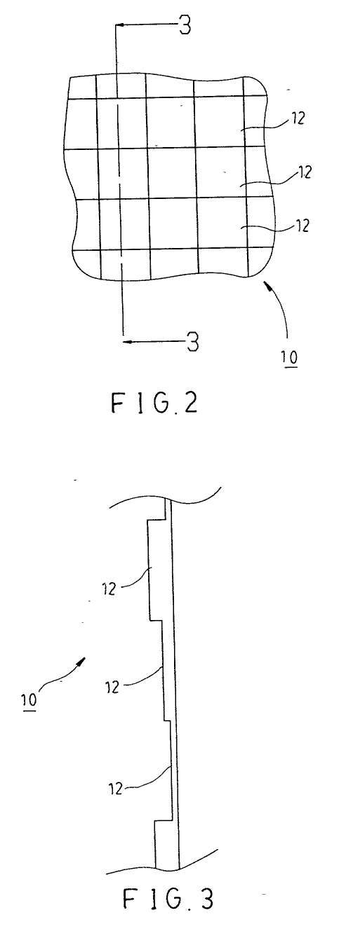

Referring to FIGS. 2, 3 and 5, a light filter 10 is disposed in front of a CCD (charge-coupled device) 20, comprising multiple light-filtering portions 12 of thin, medium and thick thickness corresponding to the red, green and blue photosensitive pixels of the CCD 20 respectively. The light-filtering portions 12 have respective planar front and back surfaces. The planar front and back surfaces of each light-filtering portion 12 are disposed in parallel.

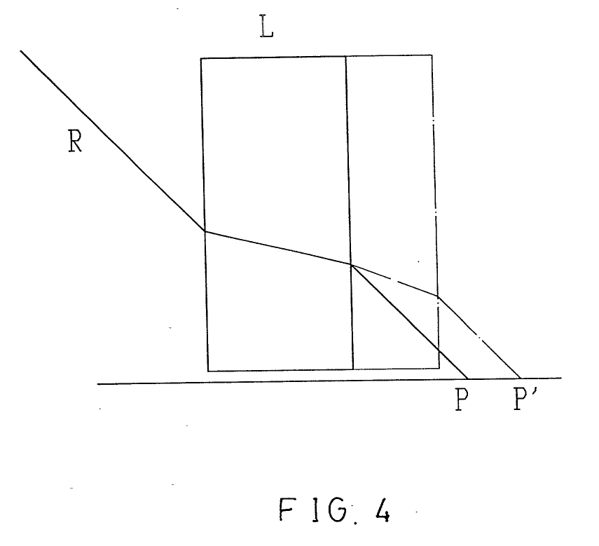

Referring to FIG. 4, when light ray R is refracted through a lens L, the distance of the imaged position P or P′ is directly proportional to the thickness of the lens L.

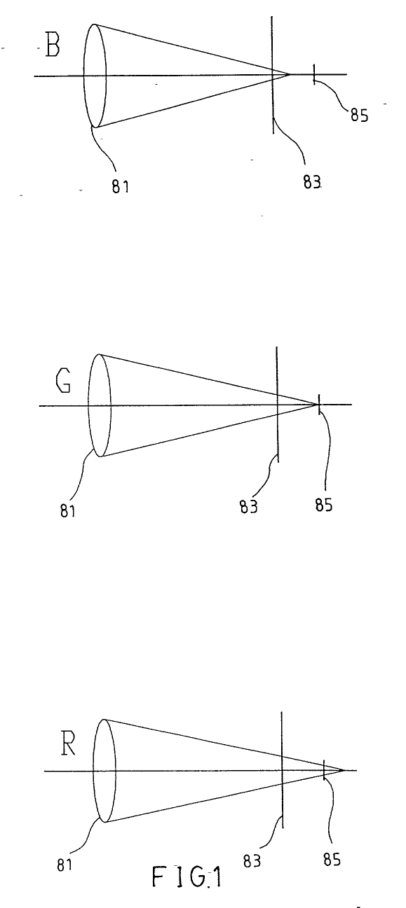

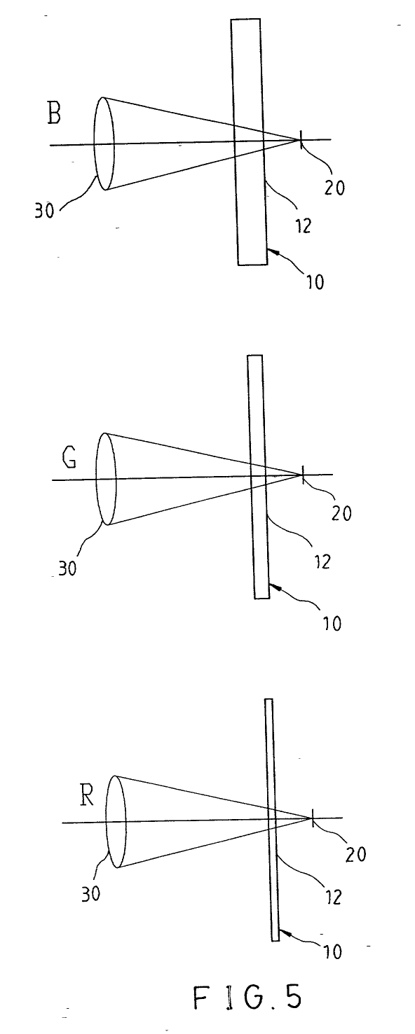

Before installation of the light filter 10 in between the CCD 20 and the lens 30, the red, green and blue colors, similar to the status shown in FIG. 1, are imaged on far, middle and near positions respectively. After installation of the light filter 10 in between the CCD 20 and the lens 30 as shown in FIG. 5, the three prime colors are imaged on the same position, i.e., focused onto the CCD 20 accurately. The principle shown in FIG. 4, when the light-filtering portions 12 of the light filter 10 corresponding to red light becomes thin, the distance of image can be decreased. However, the distance of image can be increased once the light-filtering portions 12 of the light filter 10 corresponding to blue light becomes thick. Because the light-filtering portions 12 of thin, medium and thick thickness of the light filter 10 are respectively disposed corresponding to the red, green and blue photosensitive pixels of the CCD 20, red, green and blue colors are imaged on the CCD 20.

As indicated above, the present invention provides a light filter 10, which enables the three prime colors to be accurately focused onto the charge-coupled device, so that high image quality is achieved. Because the three prime colors are focused onto the same focal point at the CCD, the invention eliminates the problem of poor image quality of the prior art design due to not being capable of focusing the three prime colors onto a same plane.

It is to be understood that the drawings are. designed for purposes of illustration only, and are not intended for use as a definition of the limits and scope of the invention disclosed.

What the invention claimed is:

1. A light filter comprising a plurality of light-filtering portions of thin, medium and thick thickness corresponding to the red, green and blue photosensitive pixels of a charge-coupled device disposed behind said filter for enabling red, green and blue colors of light passing through said light filter to be mapped onto said charge-coupled device at the same distance.

2. The light filter of claim 1, wherein said light-filtering portions each have a planar front surface and a planer back surface.

3. The light filter of claim 2, wherein the planar front and back surfaces of each of said light-filtering portions are disposed in parallel.
